(19) United States
(12) Patent Application Publication
(10) Pub. No.: US 2003/0144880 A1
(43) Pub. Date: Jul. 31, 2003

(54) Method and program for creating healthcare facility order types

(76) Inventors: Kaivan Talachian, Richmond Hill (CA); Sayeh Radpay, Toronto (CA); Meetali Acharya, Burlington (CA); Eric S. Paul, North York (CA)

Correspondence Address: Wallenstein & Wagner, Ltd., 53rd Floor, 311 S. Wacker Drive, Chicago, IL, 60606-6622, US

(21) Appl. No.: 10/236,478

(22) Filed: Sep. 6, 2002

Related U.S. Application Data
(63) Continuation-in-part of application No. 10/135,180, filed on Apr. 30, 2002.
Application No. 10/135,180 is a continuation-in-part of application No. 10/059,929, filed on Jan. 29, 2002.
(63) Continuation-in-part of application No. 10/159,845, filed on May 31, 2002.
(63) Continuation-in-part of application No. 10/160,429, filed on May 31, 2002.
(63) Continuation-in-part of application No. 10/161,221, filed on May 31, 2002.
(63) Continuation-in-part of application No. 10/160,444, filed on May 31, 2002.
(63) Continuation-in-part of application No. 10/160,565, filed on May 31, 2002.
(63) Continuation-in-part of application No. 10/160,563, filed on May 31, 2002.
(60) Provisional application No. 60/376,625, filed on Apr. 30, 2002.
(60) Provisional application No. 60/377,027, filed on Apr. 30, 2002.
(60) Provisional application No. 60/376,655, filed on Apr. 30, 2002.
(60) Provisional application No. 60/384,717, filed on May 31, 2002.
(60) Provisional application No. 60/385,176, filed on May 31, 2002.
(60) Provisional application No. 60/384,607, filed on May 31, 2002.

(51) Int. Cl. G06F 17/60

(52) U.S. Cl. 705/2

(57) ABSTRACT

A computerized system for creating a new customized order type for use in a computerized healthcare facility system. A computer generates a template, preferably displayed as a window, for collecting information for creating an order type customized for use by a particular healthcare facility. A user can enter the required information and save the order type as a standard order type for later order entry by a clinician or other user of the healthcare facility system.

### RELATED APPLICATIONS

The present application claims the benefit of the following U.S. Provisional Applications: “Medical Delivery and Information System for Use in Health Care Facilities,” Serial No. 60/377,027, filed Apr. 30, 2002; “System and Method for Integrating Structural Clinical Documentation With Point of Care Treatment of a Patient,” Serial No. 60/376,625, filed Apr. 30, 2002; “Infusion Therapy System and Method,” Serial No. 60/376,655, filed Apr. 30, 2002; “System And Method For Supporting Clinical Decisions During Patient Care And Treatment,” Serial No. 60/384,717, filed May 31, 2002; “Nursing Order Workflow System and Method,” Serial No. 60/385,176 filed May 31, 2002; “System And Method For Facilitating Orders During Patient Care And Treatment,” Serial No. 60/384,607, filed May 31, 2002; and incorporates such applications herein by reference.

This application is a continuation-in-part of the following co-pending applications: “Medical Treatment Verification System and Method,” Ser. No. 10/135,180, filed Apr. 30, 2002; “Automated Messaging Center System And Method For Use With a Healthcare System,” Ser. No. 10/159,845, filed May 31, 2002; “Infusion Therapy Bar Coding System and Method,” Ser. No. 10/160,429, filed May 31, 2002; “System and Method for Providing Multiple Units of Measurement,” Ser. No. 10/161,221, filed May 31, 2002; “Healthcare Database Management Offline Backup and Synchronization System and Method,” Ser. No. 10/160,444, filed May 31, 2002; “System And Method For Obtaining Information From A Bar Code For Use With A Healthcare System,” Ser. No. 10/160,565, filed May 31, 2002; “System And Method For Facilitating Patient Care And Treatment,” Ser. No. 10/160,563, filed May 31, 2002; and incorporates such applications herein by reference.

Additionally, the present application is being filed concurrently with and incorporates by reference the following applications: “Method and Program for Providing a Maximum Concentration of a Drug Additive in a Solution,” Ser. No. ______; “Method and Program for Identifying Multiple Diluent Solutions for Use in Drug Delivery With a Healthcare System,” Ser. No. ______; and “System and Method for Facilitating Time-Based Infusion Orders,” Ser. No. ______.

### TECHNICAL FIELD

The present invention is generally directed to a method and program for creating customized order types, and more particularly to a computerized method and program designed for implementation with a healthcare facility system for creating customized order types for the entry of new orders in the system.

### BACKGROUND OF THE INVENTION

Healthcare facilities employ orders to admit, treat and discharge patients in the facility's care. The administration staff and medical clinicians use orders to communicate with different departments within the facility, and to provide a written record of the patient's stay. The order process at a healthcare facility is extremely important to running the facility as efficiently as possible.

Terminology, classification and processing of different order types are not standardized in healthcare facilities. Moreover, pharmacy systems and other computerized healthcare facility systems on the market today do not allow users to define their own order types. This prevents the users from customizing orders based on their best practice.

### SUMMARY OF THE INVENTION

The present system allows order type customization that provides the capability to build facility defined order types to further facilitate order entry and order processing within a healthcare facility. With the defined order types, users of the system can easily customize order entry and processing.

In one embodiment, a system for creating customized order types for use in order entry for a healthcare facility system comprises a computer configured to generate a new order type template for obtaining information for creating a new order type for use in a healthcare facility. The computer is further configured to receive information to complete the new order type from a user of the system. The template is preferably displayed as a window with a number of fields that require completing. A user creating a new order type provides the necessary information to fill in the fields. Some of this information may be in the form of selecting an item from a list of items provided by the computer, for example in a pull down menu.

In one form of the system, some of the information for completing the template may include: an order type name for the new order type; an order class and (possibly) sub-class for the new order type; and a charge code for the new order type. Other information relevant to an order type can also be sought by the system. Preferably, drop down menus are provided for the class and sub-class fields.

The system can be used for an order types utilized by a healthcare system. These may include admitting orders, discharge orders and medical treatment orders (e.g., prescriptions for drugs, medications, infusions etc.).

In one preferred embodiment of this system, the new order type template is designed to create new infusion orders. In this instance, the order class preferably consists of the following items: continuous infusion; intermittant infusion; single dose infusion; and total dose infusion.

The system preferably includes an interface for connecting the computer to a network of additional devices in the healthcare facility system. This allows other users of the healthcare facility system to create and/or use new order types.

In another embodiment, a method of creating new standard order types in a computerized healthcare facility system comprises the steps of providing a computer for generating a request for information for creating a new order type for the healthcare facility system, receiving the information by the computer from a user of the healthcare facility system to complete the new order type and, saving the new order type in the healthcare facility system database as a standard order type.

The receiving information step may comprise receiving identification of the following: an order type name for the new order type; an order class for the new order type; and a charge code for the new order type. The method may include providing a drop down menu for allowing the user to identify certain of the requested information, such as the order class and sub-class.

The method may further comprise providing an interface for connecting the computer to a network of additional devices in the healthcare facility. A user may then create a new order type from one of the additional devices.

In yet another embodiment, a computer program product for creating a new order type for use in a healthcare facility system comprises a computer usable medium having computer readable program code embodied therein, the program code including a first portion for generating a template for receiving information for the creation of a new order type for use in the health care facility system and, a second portion for placing the information received from a user of the system into the new order type and saving the new order type.

The program may further comprise a third portion for generating a drop down menu for selection of a portion of the information for the creation of a new order type. Drop down menus may be for an order type class and sub-class.

The computer program product may specifically include code for generating a request for information relating to an order type name for the new order type or a charge code for the new order type.

Further aspects of the invention are disclosed in the detailed description of the preferred embodiment, the drawings and the claims.

### BRIEF DESCRIPTION OF THE DRAWINGS

FIG. 1 is a screen shot of an Order Type—(New) window in accordance with the present invention; and,

FIG. 2 is a screen shot of an Order Types window.

### DETAILED DESCRIPTION OF THE PREFERRED EMBODIMENT

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The facility definable order types system of the present invention is preferably used in connection with a medical delivery and information management system for use in hospitals, pharmacies and other similar healthcare facilities (i.e., a healthcare facility system). The preferred healthcare facility system uses a combination of bar coding and wireless technology to support the clinical needs of physicians, pharmacists, nurses and other healthcare personnel (i.e., clinicians). Moreover, the preferred healthcare facility system allows healthcare professionals and administrators to make better decisions and reduce costs, while improving patient safety and quality of care.

Specifically, among other things, the preferred healthcare system comprises a computer software program integrated with various other healthcare facility systems, that provides for: electronic on-line access to patient information (e.g., medication history, current medications, allergies, reactions) and medication administration information, preferably in the form of an electronic medical record for the patient; instant medication ordering at the patient bedside; clinical screening of medications; an electronic messaging link between physicians, pharmacists and nurses; standardized dosage and special administration instructions; and, an improved quality of record keeping and inventory tracking. Functionality included within the preferred healthcare system can be split between a number of different devices, such as end-user workstations (e.g., personal computers), medication carts with computer interfaces and hand-held computerized devices (e.g., electronic tablets or personal digital assistants). The hand-held devices are preferably operated at the patient bedside. Conventional software code can be used to implement the unique functionality of the systems described herein. The code can be provided on any computer readable or usable medium.

The present system provides a means for creating an order type for use in the healthcare facility. Such order types can range from those concerned with the administration of the facility to those specifically concerned with patient care (i.e., treatment of the patient).

The present order system may have a number of pre-defined standard order types, such as “Repeating Dose” and “Adjusting Doses” order types. These order types can be selected from a window generated by a computer in the system, and can be readily edited (for example to change a dosage amount in the standard order) with an editor in the system.

The system also allows the facility to define new standard order types, for example “infusion order types,” using pre-defined system infusion order types as a template. While infusion order types are used as an example to describe the preferred embodiment of the invention, the system may include other templates to create other order types. The templates can be available, for example, from a main window or menu, or from a portion of the program relating specifically to the order process. The order types that are defined by the facility can be made available for selection in a “wizard” or other sub-component of the system during an order entry. The new order types can be for any type of order necessary for running the facility, such as admitting and discharge orders, or prescription or drug or medication treatment orders.

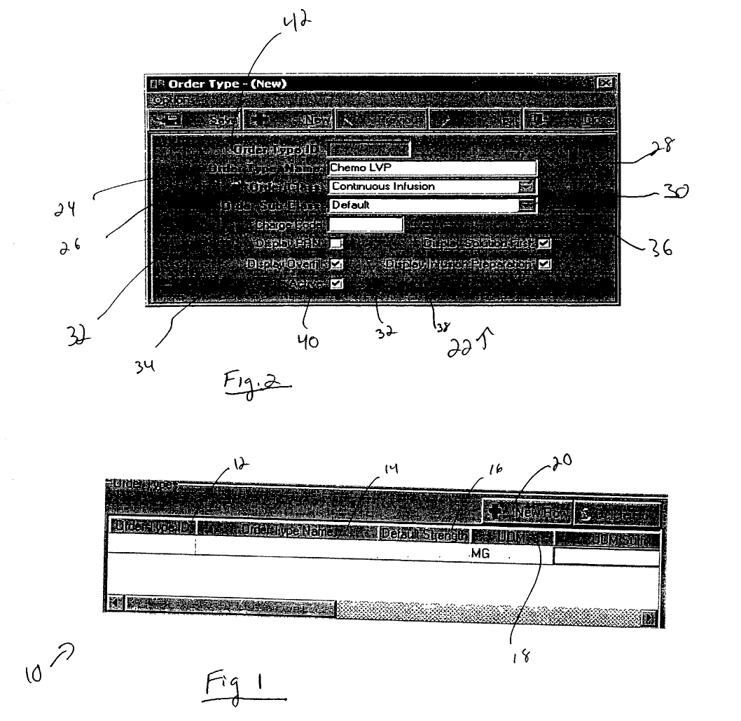

Referring to FIG. 1, an Order Type window 10 can be accessed through a computer or hand-held device in the healthcare facility system. This window 10 can be set up to list all order types that have been defined for the facility, and provide certain information, such as the Order Type ID 12, Order Type Name 14, Default Strength 16, UOM (unit of measure) 18 etc. Similarly, a user of the system may perform a search to limit the number of standard order types displayed (e.g., a search for a particular drug type will limit the display to only those order types pertaining to the searched drug type). No specific order types are listed in FIG. 1.

To create a new order type, the user clicks the “new row” icon 20 which links the user to an Order Type—(New) window 22 shown in FIG. 2. At this window 22, a user of the system can then create new order types for the facility. The system can be configured so that only certain types of users have the ability to create order types.

To create a new order, the system requires information so that certain fields identified in the window 22 can be completed. Some of this information can then be utilized in the list of order types in the Order Types window 10.

In an “Order Type Name” field 24, the user can enter a name for the new order type. In the example shown in FIG. 2, the new order type name is given as “Chemo LVP.” The Order Type Name is defined by the healthcare facility and can be references everywhere in the system.

The particular healthcare facility utilizing the system can select appropriate order classes and order sub-classes when creating custom order types. The user can select an “Order Class” 26 from a drop down menu 28. This drop down menu 28 can provide a list of predefined order classes. Preferably, for a system designed for creating orders for infusion treatments, the pre-defined order class may consist of the following: Continuous Infusion; Intermittant Infusion; Single Dose Infusion; and Total Dose Infusion. In the example of FIG. 2, the user selected “Continuous Infusion” as the order class for the new order type. Other order sets can be developed for different patient treatments. For example, the facility may want to create an epidural order set, or a patient controlled analgesia order set.

Another drop down menu 30 is provided for an Order Sub-Class which is activated in appropriate situations. For example, if the Order Type is based on the order class of “Continuous Infusion” the user would then select from a sub-class consisting of: Default; Titrating; and Tapering. Other sub-classes can be available for other classes. In some situations, an order sub-class may not be necessary. In which case the menu 30 would either not be activated, or have a single nondescript designation.

A specific charge code or billing algorithm can be linked to the new order type creation to facilitate customized charge capture based on the order type. In this regard, the Order Type (New) window 22 also may include a “Charge Code” field 32. An appropriate charge code for the particular order, in accordance with the billing policies of the particular facility, may be inserted in this field. The Charge Code field 32, for example, may indicate that an additional charge is associated with the particular type of infusion. The additional fee may be a per infusion bag fee that is charged in addition to any item (e.g., drug or medication) fee whenever an order is placed using this particular order type. If there is no additional per bag fee, the charge code could be left blank.

The Order Type—(New) window 22 also includes a “Display PRN” check box 32. During a subsequent order entry using the new order type, the PRN check box is only available if the Display PRN check box in the Order Type—(New) window 22 is checked. Otherwise this order type cannot be ordered as a PRN. If the check box is available in the new order type created, the user can check the box, and the drug or medication will be administered “as needed.”

Similarly, the window 22 also includes a “Display Overfill” check box 34. If checked when creating a new order type, this box will appear in the newly created order type for a subsequent order entry.

The Order Type—(New) window 22 further includes a “Display Solution First” check box 36. During order entry of infusions, both the available solutions and additives are listed for selection. If the Display Solution First check box 36 is checked, the solutions will be listed before the additives. Otherwise, the additives are listed before the solutions.

The Order Type—(New) window 22 also includes a “Display Infusion Preparation” check box 38. If this window is checked, an Infusion Preparation window is displayed after order entry. The Infusion Preparation window contains information pertaining to the preparation of the ordered infusion.

The Order Type—(New) window 22 also includes an “Active” check box 40. If this box is checked the new order type will be made available throughout the system.

Another field in the Order Type—(New) window 22 is the “Order Type ID” 42. This field is preferably automatically generated and assigned by the system.

A specific label format can be attached to each new order type, and directed to any appropriate printer.

Order Types can be attached to a particular drug to automatically default the appropriate order type at the time of order entry. Users can also be provided the option to add an order type specific dose, dose unit of measure and unit of measure suffix to the new order type.

After completing the fields in the Order Type—(New) window 22, the user can save 44 the new order type in the system for subsequent use in order entry. The new order type can be stored in a database with other standard orders, and displayed in the Order Type window 10 of FIG. 1. Each department in a healthcare facility can create its own customized order types using this method. The order types can then be used to filter or display orders and generate management reports, such as workload statistics.

Although described in connection with an elaborate healthcare facility system, the functionality of the new order type system described herein, could also be a stand alone product. Alternatively, the new order type system may be part of a system that does not function like the healthcare facility system described.

While specific embodiments have been illustrated and described, numerous modifications are possible without departing from the spirit of the invention, and the scope of protection is only limited by the scope of the accompanying claims.

What is claimed is:

1. A system for creating customized order types for use in order entry for a healthcare facility system comprising:
a computer configured to generate a new order type template for obtaining information for creating a new order type for use in a healthcare facility; and,
the computer further configured to receive information to complete the new order type from a user of the system.

2. The system of claim 1 wherein the information includes identification of an order type name for the new order type.

3. The system of claim 1 wherein the information includes identification of an order class for the new order type.

4. The system of claim 3 wherein the information includes identification of an order sub-class for the new order type.

5. The system of claim 1 wherein the information includes identification of a charge code for the new order type.

6. The system of claim 3 wherein the new order type is for an infusion treatment.

7. The system of claim 6 wherein the new order template includes a drop down menu for receiving the information identifying the order class.

8. The system of claim 7 wherein the drop down menu for receiving the information identifying the order class includes a continuous infusion class.

9. The system of claim 7 wherein the drop down menu for receiving the information identifying the order class includes a intermittant infusion class.

10. The system of claim 7 wherein the drop down menu for receiving the information identifying the order class includes a single dose infusion class.

11. The system of claim 7 wherein the drop down menu for receiving the information identifying the order class includes a total dose infusion class.

12. The system of claim 1 further comprising an interface for connecting the computer to a network of additional devices in the healthcare facility system.

13. A method of creating new standard order types in a computerized healthcare facility system comprising the steps of:
providing a computer for generating a request for information for creating a new order type for the healthcare facility system;
receiving the information by the computer from a user of the healthcare facility system to complete the new order type; and,
saving the new order type in the healthcare facility system as a standard order type.

14. The method of claim 13 wherein the receiving information step comprises receiving identification of an order type name for the new order type.

15. The method of claim 13 wherein the receiving information step comprises receiving identification of an order class for the new order type.

16. The method of claim 14 wherein the receiving information step comprises receiving identification of an order sub-class for the new order type.

17. The method of claim 13 wherein the receiving information step comprises receiving identification of a charge code for the new order type.

18. The method of claim 15 further comprising providing a drop down menu for allowing the user to identify the order class.

19. The method of claim 16 further comprising providing a drop down menu for allowing the user to identify the order sub-class.

20. The method of claim 13 further comprising providing an interface for connecting the computer to a network of additional devices in the healthcare facility.

21. A computer program product for creating a new order type for use in a healthcare facility system, the computer program product comprising:
a computer usable medium having computer readable program code embodied therein, the program code including
a first portion for generating a template for receiving information for the creation of a new order type for use in the health care facility system; and,
a second portion for placing the information received from a user of the system into the new order type and saving the new order type.

22. The computer program product of claim 21 further comprising a third portion for generating a drop down menu for selection of a portion of the information for the creation of a new order type.

23. The computer program product of claim 21 wherein the drop down menu is for obtaining selection of an order type class.

24. The computer program product of claim 21 wherein the drop down menu is for obtaining selection of an order type sub-class.

25. The computer program product of claim 21 wherein the first portion generates a request for identification of an order type name for the new order type.

26. The computer program product of claim 21 wherein the first portion generates a request for identification of a charge code for the new order type.
